(19) United States
(12) Patent Application Publication
(10) Pub. No.: US 2026/0146903 A1
(43) Pub. Date: May 28, 2026

(54) High Temperature Strain Gauge

(71) Applicant: Microchip Technology Incorporated, Chandler, AZ (US)

(72) Inventors: Patrick MCFARLAND, Gilbert, AZ (US); Steve NAGEL, Chandler, AZ (US); Bomy CHEN, Newark, CA (US); Arthur B. ECK, Gilbert, AZ (US)

(73) Assignee: Microchip Technology Incorporated, Chandler, AZ (US)

(21) Appl. No.: 19/017,637

(22) Filed: Jan. 11, 2025

Related U.S. Application Data
(60) Provisional application No. 63/724,725, filed on Nov. 25, 2024.

(51) Int. Cl. G01L 1/22

(52) U.S. Cl. CPC G01L 1/2206

(57) ABSTRACT

A system and method for a high temperature strain gauge are disclosed. The system may include a mechanical component. The system may also include a strain gauge to measure a strain of the mechanical component. The strain gauge may include a first end of a first support leg mounted on the mechanical component. The strain gauge may also include a first end of a second support leg mounted on the mechanical component opposite the first support leg. The second support leg may be symmetric to the first support leg and have a size substantially similar as the first support leg. The strain gauge may also include a strain sensor between a second end of the first support leg and a second end of the second support leg.

### PRIORITY

This application claims priority to U.S. Provisional Patent Application No. 63/724,725 filed November 25, 2024, the contents of which are hereby incorporated in their entirety.

### TECHNICAL FIELD

The present disclosure relates to strain gauges, and, in particular, to a high temperature strain gauge.

### BACKGROUND

A high-temperature strain gauge is a type of strain gauge designed to measure strain in environments with high temperatures (e.g., from 200°C (392°F) to over 1000°C (1832°F)). These gauges may be constructed from materials that can withstand elevated temperatures without significant degradation in performance, such as nickel-chromium alloys or platinum-tungsten alloys. High-temperature strain gauges may be used to monitor strain of components in a variety of applications, including, but not limited to, aerospace (e.g., measuring strain in engine components, turbine blades, and other high-temperature parts), automotive (e.g., monitoring strain in engine components, exhaust systems, and turbochargers.), and power generation applications (e.g., measuring strain in turbine blades, boiler tubes, and other components in power plants).

### SUMMARY OF THE INVENTION

Aspects provide systems and methods for a high temperature strain gauge. Examples of the present disclosure may include an apparatus. The apparatus may include a first support leg. The apparatus may also include a second support leg opposite the first support leg. The second support leg may be symmetric to the first support leg and have a size substantially similar as the first support leg. The apparatus may also include a strain sensor between an end of the first support leg and an end of the second support leg.

In combination with any of the above examples, the first support leg may include a first fin. The second support leg may include a second fin.

In combination with any of the above examples, the first support leg may be positioned at an angle relative to the second support leg.

In combination with any of the above examples, a spacing between the first support leg and the second support leg may be selected based on a thickness of the strain sensor.

In combination with any of the above examples, a surface area of the first support leg may be based on at least one of a thermal conductivity of a material from which the first support leg is manufactured, an air flow across the first support leg, or an ambient air temperature of an environment surrounding the first support leg.

In combination with any of the above examples, a surface area of the first support leg may be based on at least one of an operating temperature of the strain sensor, an air flow across the first support leg, or an ambient air temperature of an environment surrounding the first support leg.

In combination with any of the above examples, a thermal conductivity of the first support leg and a thermal conductivity of the second support leg may be substantially similar.

Alone or in combination with any of the above examples, examples of the present disclosure may include a method. The method may include mounting a first end of a first support leg on a surface of a component. The method may also include mounting a first end of a second support leg on the surface of the component opposite the first support leg. The second support leg may be symmetric to the first support leg and may have a size substantially similar as the first support leg. The method may additionally include locating a strain sensor between a second end of the first support leg and a second end of the second support leg.

In combination with any of the above examples, the first support leg may include a first fin. The second support leg may include a second fin.

In combination with any of the above examples, the method may include positioning the first support leg at an angle relative to the second support leg.

In combination with any of the above examples, the method may include spacing the second end of the first support leg apart from the second end of the second support leg is selected based on a thickness of the strain sensor.

In combination with any of the above examples, a surface area of the first support leg may be based on at least one of a thermal conductivity of a material from which the first support leg is manufactured, an air flow across the first support leg, or an ambient air temperature of an environment surrounding the first support leg.

In combination with any of the above examples, a surface area of the first support leg may be based on at least one of an operating temperature of the strain sensor, an air flow across the first support leg, or an ambient air temperature of an environment surrounding the first support leg.

In combination with any of the above examples, a thermal conductivity of the first support leg and a thermal conductivity of the second support leg may be substantially similar.

Alone or in combination with any of the above examples, examples of the present disclosure may include a system. The system may include a mechanical component. The system may also include a strain gauge to measure a strain of the mechanical component. The strain gauge may include a first end of a first support leg mounted on the mechanical component. The strain gauge may also include a first end of a second support leg mounted on the mechanical component opposite the first support leg. The second support leg may be symmetric to the first support leg and have a size substantially similar as the first support leg. The strain gauge may also include a strain sensor between a second end of the first support leg and a second end of the second support leg.

In combination with any of the above examples, the first support leg may include a first fin. The second support leg may include a second fin.

In combination with any of the above examples, the first support leg may be positioned at an angle relative to the second support leg.

In combination with any of the above examples, a surface area of the first support leg may be based on at least one of a thermal conductivity of a material from which the first support leg is manufactured, an air flow across the first support leg, or an ambient air temperature of an environment surrounding the first support leg.

In combination with any of the above examples, a surface area of the first support leg may be based on at least one of an operating temperature of the strain sensor, an air flow across the first support leg, or an ambient air temperature of an environment surrounding the first support leg.

In combination with any of the above examples, a thermal conductivity of the first support leg and a thermal conductivity of the second support leg may be substantially similar.

### BRIEF DESCRIPTION OF THE DRAWINGS

The figures illustrate examples of systems and methods for a high temperature strain gauge.

FIG. 1 illustrates a high temperature strain gauge, according to examples of the present disclosure;

FIG. 2 illustrates a device including components that may be monitored using a high temperature strain gauge, according to examples of the present disclosure;

FIG. 3 illustrates a method performed for implementing a high temperature strain gauge, according to examples of the present disclosure; and

FIG. 4 illustrates a more detailed method performed for implementing a high temperature strain gauge, according to examples of the present disclosure.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

According to an aspect of the invention, systems and methods for a high temperature strain gauge are provided. Traditional high temperature strain gauges may be costly because of the design constraints for operation at extreme temperatures (e.g., from 200°C (392°F) to over 1000°C (1832°F)) and use of expensive materials that can withstand the extreme temperatures. The strain gauge of the present disclosure may use support legs to measure strain of a component operating at high temperatures. The support legs may act as heat sinks to allow the strain to be monitored from a location having a lower temperature. The strain gauge of the present disclosure may have a lower cost when compared to the cost of a traditional strain gauge used to measure strain in high temperature environments. Because the strain gauge of the present disclosure may have a lower cost, devices operating at extreme temperatures may include more strain gauges to provide data collection at a more locations. The additional data collection may provide an increased understanding of the performance and fatigue of the device, both in the short- and long-term. Additionally, the data provided by the strain gauges disclosed herein may provide data for use in predictive maintenance and pre-failure diagnosis of devices nearing failure. This predictive data may enable an operator to diagnosis fatigue and perform scheduled maintenance before a catastrophic failure.

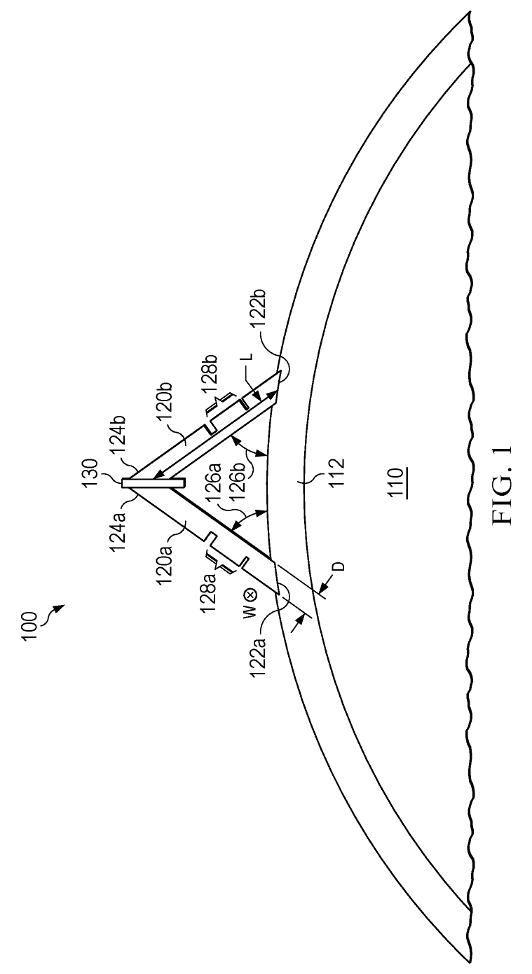

FIG. 1 illustrates a high temperature strain gauge, according to examples of the present disclosure. System 100 may be installed on surface 112 of mechanical component 110. System 100 may be used to monitor the movement (e.g., strain) of mechanical component 110 at the installation location.

System 100 may include support legs 120a and 120b. Support legs 120a and 120b may be formed in any suitable manner, including, but not limited to, laser cutting, stamping, molding, or three-dimensional printing. For example, laser cutting support legs 120a and 120b may result in increased elasticity of support legs 120a and 120b and may increase the amount of cooling per centimeter of support leg 120a and 120b. Support legs 120a and 120b may be manufactured such that support leg 120a is a mirror image of support leg 120b. The symmetry of support legs 120a and 120b may allow support leg 120a and support leg 120b to expand and contract at the same rate in response to temperature changes and forces applied to mechanical component 110 (e.g., support legs 120a and 120b have a substantially similar thermal conductivity).

Ends 122a and 122b of support legs 120a and 120b, respectively, may be coupled to surface 112 of mechanical component 110. Ends 122a and 122b may be coupled to surface 112 using any suitable method including, but not limited to, soldering, welding, adhesive, mechanical fasteners (e.g., bolts, rivets, or clamps), or any combination thereof. Support legs 120a and 120b may have substantially the same size and be positioned such that support leg 120a is opposition and a mirror image of support leg 120b (e.g., support leg 120a is substantially symmetric to support leg 120b).

Support legs 120a and 120b may be positioned on surface 112 at angles 126a and 126b, respectively. For example, angle 126a of support leg 120a may be approximately 30 to approximately 60 degrees relative to surface 112. Angle 126a may be approximately equal to angle 126b. Angle 126a and angle 126b may be selected based on the operating temperature of mechanical component 110, temperature capability of sensor 130 (described below), the heat dissipation capabilities of support legs 120a and 120b, or any combination thereof. For example, angle 126a and angle 126b may be smaller when the difference between the temperature of mechanical component 110 and the temperature capability of sensor 130 is lower and angle 126a and angle 126b may be larger when the difference between the temperature of mechanical component 110 and the temperature capability of sensor 130 is higher. As such, angle 126a and angle 126b may increase as the amount of heat dissipated by support legs 120a and 120b increases.

Support legs 120a and 120b may act as heat sinks to dissipate heat from surface 112 to ends 124a and 124b. For example, the temperature at surface 112 may be approximately 800^{o}C and the temperature at ends 124a and 124b may be below approximately 150^{o}C. Support legs 120a and 120b may be formed of any suitable material that can withstand the temperatures at surface 112 and provide adequate heat dissipation. For example, support legs 120a and 120b may be any suitable material with a high melting point, such as, but not limited to, ceramic, ceramic matric composites (CMCs), nickel, nickel-based alloys, tungsten. refractory metal alloys (e.g., molybdenum-based TZM), or titanium aluminides. Support legs 120a and 120b may be made of the same material or different materials. In examples where support legs 120a and 120b are made of different materials, support legs 120a and 120b may be made of materials having substantially the same thermal conductivity such that support leg 120a expands and contracts at the same rate as support leg 120b.

Sensor 130 may be placed between ends 124a and 124b of support legs 120a and 120b, respectively. Sensor 130 may be any suitable type of sensor for detecting strain, including, but not limited to, a pressure sensor, piezo-electric sensor, compression coil, or inductive flux core movement sensor. Sensor 130 may measure movement of support legs 120a and 120b and convert the physical movement into an electrical signal that may be provided to a control circuit for further processing.

The size of support legs 120a and 120b may be based on the expected temperature of surface 112 during operation of device 100 and the thermal conductivity of support legs 120a and 120b. Additionally, or in the alternative, the size of support legs 120a and 120b may be based on the temperature capability of sensor 130. Further, the size of support legs 120a and 120b may be based on the air flow across support legs 120a and 120b (e.g., greater air flow may use less surface area) and the ambient air temperature (e.g., a lower ambient air temperature may use less surface area) of the environment surrounding support legs 120a and 120b. For example, where the expected temperature of surface 112 is approximately 1000^{o}C and the maximum operational temperature of sensor 130 is approximately 150^{o}C, support legs 120a and 120b may be sized such that support legs 120a and 120b dissipate at least 850^{o}C of heat between ends 122a and 122b and ends 124a and 124b, respectively. The surface area of support legs 120a and 120b for dissipation of the amount of heat may be determined based on the thermal conductivity of the material from which support legs 120a and 120b are made, the temperature capability of sensor 130, the airflow across support legs 120a and 120b, the ambient air temperature of the environment surrounding support legs 120a and 120b, or any combination thereof. In some examples, the length. (l) of support legs 120a and 120b may be at least one centimeter (e.g., length between end 122a and end 124a and end 122b and 124b, respectively), between approximately ten and approximately 30 centimeters, or between approximately one and approximately 50 centimeters. By way of example, the width (w) of support legs 120a and 120b may be between approximately 10 and approximately 20 centimeters. The depth (d) of support legs 120a and 120b may be determined based on the contact area at ends 122a and 122b, respectively, to provide adhesion of support legs 120a and 120b to surface 112 and to provide thermal transfer from surface 112 to sensor 130. While support legs 120a and 120b are shown in FIG. 1 as having a uniform cross section along the length of support legs 120a and 120b, support legs 120a and 120b may have any suitable cross section. For example, the cross section of support leg 120a may be greater at end 122a than end 124a. As another example, the cross section of support leg 120a may vary along the length of support leg 120a. Additionally, while support legs 120a and 120b are shown in FIG. 1 as straight, in other examples support legs 120a and 120b may be curved. In some examples, support legs 120a and 120b may be solid, hollow, have an internal lattice/honeycomb structure, or any combination thereof.

Additionally, in some examples, support legs 120a and 120b may have one or more fins 128a and 128b, respectively, to further increase the surface area for heat dissipation. Fins 128a and 128b may be angled to direct airflow around or across support legs 120a and 120b. In some examples, fins 128a and 128b may be arranged to cause airflow around support legs 120a and 120b to be turbulent, thus increasing the heat dissipation of support legs 120a and 120b. Fins 128a and 128b may have any suitable shape to provide heat dissipation, such as curved, wavy, corrugated, or any combination thereof. In some examples, fins 128a and 128b may be tapered.

Ends 124a and 124b may be spaced from each other at a distance based on the size of sensor 130. Specifically, ends 124a and 124b may be spaced from each other by a distance less than the thickness of sensor 130. For example, ends 124a and 124b may be spaced from each other by at least approximately 70% to approximately 80% of the thickness of sensor 130 or between at least approximately 50% to approximately 90% of the thickness of sensor 130.

During operation, mechanical component 110 may experience stress and strain and surface 112 may deform or move based on the forces. For example, surface 112 may be stretched or compressed by the forces. The movement of surface 112 may be translated to sensor 130 via support legs 120a and 120b which may move in a similar manner as surface 112. Specifically, instead of being mounted to surface 112, sensor 130 may be mounted between ends 124a and 124b. As surface 112 moves due to stress and strain, ends 124a and 124b may also move in a similar manner such that sensor 130 may detect the movement of ends 124a and 124b and thus measure the strain of surface 112. Support legs 120a and 120b may be formed of a material that has approximately the same rigidity across the temperature range at which system 100 may operate. The rigidity of support legs 120a and 120 may be based on the type of sensor 130, the material from which support legs 120a and 120b are manufactured, the temperature range at which system 100 operations, any combination thereof, or any other suitable factor. For example, some materials may become more flexible at higher temperatures and therefore the rigidity of support legs 120a and 120b may be greater at lower temperatures to maintain rigidity at higher temperatures as the material becomes flexible. In examples where the rigidity of support legs 120a and 120b varies across the operating temperature range, sensor 130 may be calibrated to compensate for the rigidity of support legs 120a and 120b at various temperatures.

In some examples, support legs 120a and 120b may not be perfectly symmetrical. Accordingly, a control circuit receiving electrical signals from sensor 130 may account for asymmetry by sensor 130. In some examples, sensor 130 may be recalibrated on a periodic basis. Recalibration may be performed using any suitable calibration or recalibration technique, including but not limited to, by electrical characterization of system 100 when mechanical component 110 is at rest or operating at a lower temperature, electrical characterization of system 100 over the temperature range and comparing system 100 to that characterization in operation, physical removal of system 100 for evaluation and development of new calibration values, or any combination thereof.

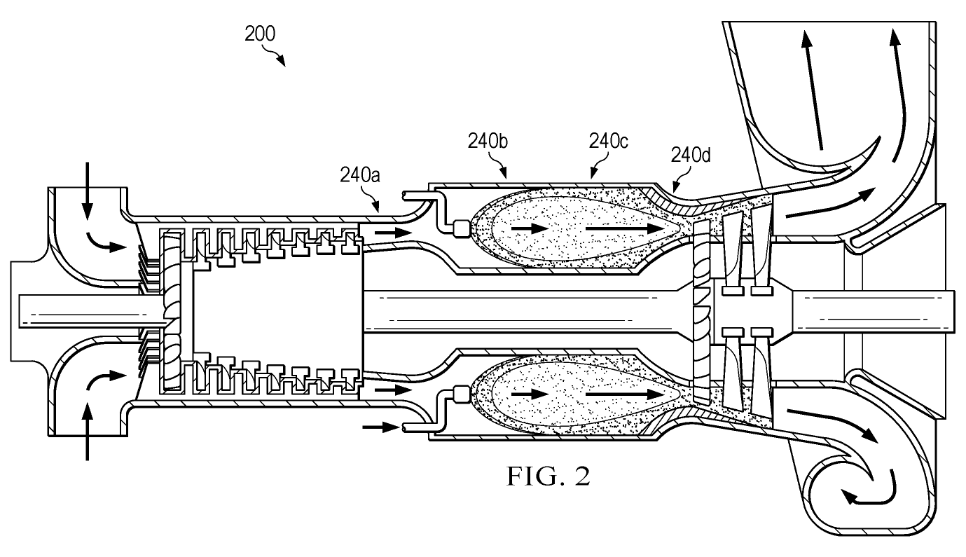

FIG. 2 illustrates a device including components that may be monitored using a high temperature strain gauge, according to examples of the present disclosure. While device 200 is shown in FIG. 2 as a turbine engine, device 200 may be any suitable device operating at high temperature and for which strain of components may be monitored, including, but not limited to devices used in aerospace (e.g., measuring strain in engine components, turbine blades, and other high-temperature parts), automotive (e.g., monitoring strain in engine components, exhaust systems, and turbochargers.), and power generation applications (e.g., measuring strain in turbine blades, boiler tubes, and other components in power plants).

One or more high temperature strain gauges, such as system 100 shown in FIG. 1, may be placed at one or more locations on device 200. For example, high temperature strain gauges may be placed at location 240a, the inlet of the combustion chamber, at locations 240b and 240c along the outer perimeter of the combustion chamber, and at location 240b at the exit of the combustion chamber. The high temperature strain gauges may be placed at intervals around the outer perimeter of the components of device 200 to provide information about the strain of device 200 at multiple locations. The change in strain measured by the high temperature strain gauges may be used to perform predictive maintenance of device 200. For example, measurements from the high temperature strain gauges may be used to identify the strain of components of device 200 during normal operation so that deviations from that strain may be identified and remedied before failure of the component. For example, the high temperature strain gauges may identify if the stress at location 240a is not symmetrical along the circumference of the inlet to the combustion chamber. The asymmetry of strain at a given location may indicate a problem with a component of device 200.

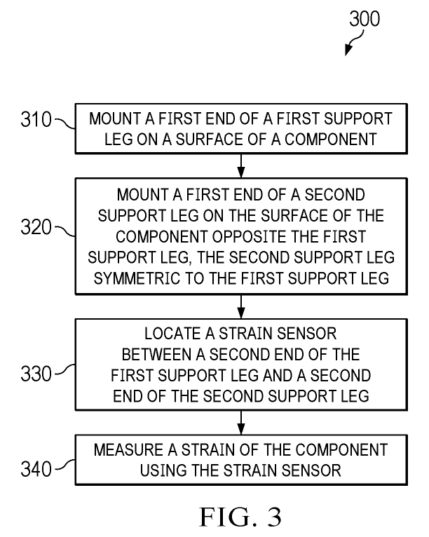

FIG. 3 illustrates a method performed for implementing a high temperature strain gauge, according to examples of the present disclosure. Method 300 may be implemented by any suitable device for installing components on devices, or any other system operable to implement method 300. For example, method 300 may be implemented by a system including a non-transitory memory including machine-readable instructions that, when executed, cause the processor to perform the steps of method 300. Although examples have been described above, other variations and examples may be made from this disclosure without departing from the spirit and scope of these disclosed examples.

Method 300 may begin at block 310 where a first end of a first support leg may be mounted on a surface of a component. The first end (e.g., end 122a of support leg 120a shown in FIG. 1) may be mounted on the surface of the component using any suitable method including, but not limited to, soldering, welding, adhesive, or any combination thereof.

At block 320, a first end of a second support leg may be mounted on a surface of a component. The first end (e.g., end 122b of support leg 120b shown in FIG. 1) may be mounted on the surface of the component using any suitable method including, but not limited to, soldering, welding, adhesive, or any combination thereof. The second support leg may be symmetric to (e.g., a mirror image of) the first support leg and be substantially the same size as the first support leg such that the first and second support legs expand and contract at the same rate in response to temperature changes and forces applied to the component (e.g., the first and second support legs have a uniform temperature gradient).

At block 330, a strain sensor (e.g., sensor 130 shown in FIG. 1) may be located between a second end of the first support leg (e.g., end 124a of support leg 120a shown in FIG. 1) and a second end of the second support leg (e.g., end 124b of support leg 120b shown in FIG. 1).

At block 340, a strain of the component may be measured using the strain sensor. For example, during operation, the component may experience stress and strain and may move based on those forces. The movement of the component may be translated to the strain sensor via the first and second support legs. The strain sensor may measure the strain based on the movement of the first and second support legs.

Although FIG. 3 discloses a particular number of operations related to method 300, method 300 may be executed with greater or fewer operations than those depicted in FIG. 3. In addition, although FIG. 3 discloses a certain order of operations to be taken with respect to method 300, the operations comprising method 300 may be completed in any suitable order.

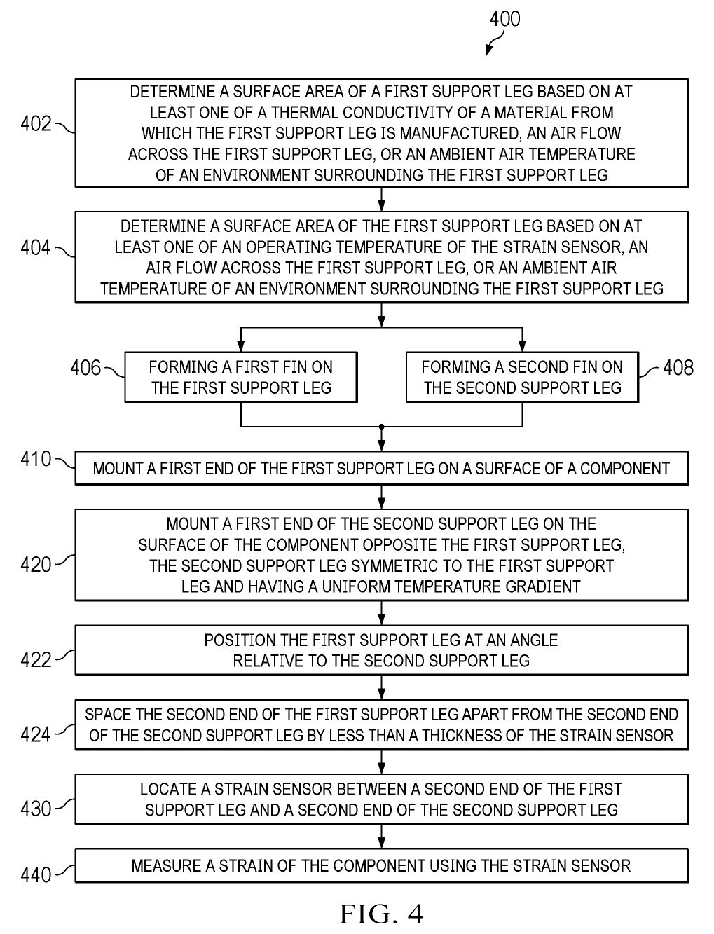

FIG. 4 illustrates a more detailed method performed for implementing a high temperature strain gauge, according to examples of the present disclosure. Method 400 may be implemented by any suitable device for installing components on devices, or any other system operable to implement method 400. For example, method 400 may be implemented by a system including a non-transitory memory including machine-readable instructions that, when executed, cause the processor to perform the steps of method 400. Although examples have been described above, other variations and examples may be made from this disclosure without departing from the spirit and scope of these disclosed examples.

Method 400 may begin at block 402 where a surface area of a first support leg may be determined based on at least one of a thermal conductivity of a material from which the first support leg is manufactured, an ambient air temperature of the environment surrounding the first support leg, or an air flow across the first support leg. For example, the surface area may be based on the surface area used to dissipate the heat generated during operation of a component to which the first support leg is mounted (at block 410) considering the air flow across the first support leg (e.g., greater air flow may use less surface area), the ambient air temperature (e.g., a lower ambient air temperature may use less surface area), the thermal conductivity (e.g., higher thermal conductivity may use less surface area), or any combination thereof. The surface area of a second support leg may be substantially equal to the surface area of the first support leg.

At block 404, a surface area of the first support leg may be determined based on at least one of an operating temperature of a strain sensor that will be positioned between the first and second support leg (at block 430), an ambient air temperature of the environment surrounding the first support leg, or an air flow across the first support leg. For example, where the expected temperature of a surface of the component is approximately 1000^{o}C and the maximum operational temperature of the strain sensor is approximately 150^{o}C, the first support leg may have a surface area such that the first support leg dissipates at least 850^{o}C of heat between a first end and a second end of the first support leg. The surface area may be based on the surface area used to dissipate the heat generated during operation of a component to which the first support leg is mounted (at block 410) considering the air flow across the first support leg (e.g., greater air flow may use less surface area), the ambient air temperature (e.g., a lower ambient air temperature may use less surface area), the thermal conductivity (e.g., higher thermal conductivity may use less surface area), or any combination thereof. The surface area of a second support leg may be substantially equal to the surface area of the first support leg.

At block 406, a first fin may be formed on the first support leg. At block 408, a second fin may be formed on the second support leg. The first fin and the second fin may increase the surface area of the first and second support leg, respectively, to provide increased heat dissipation.

At block 410, a first end of the first support leg may be mounted on a surface of a component. The first end (e.g., end 122a of support leg 120a shown in FIG. 1) may be mounted on the surface of the component using any suitable method including, but not limited to, soldering, welding, adhesive, or any combination thereof.

At block 420, a first end of the second support leg may be mounted on a surface of a component. The first end (e.g., end 122b of support leg 120b shown in FIG. 1) may be mounted on the surface of the component using any suitable method including, but not limited to, soldering, welding, adhesive, or any combination thereof. The second support leg may be symmetric to (e.g., a mirror image of) the first support leg and be substantially the same size as the first support leg such that the first and second support legs expand and contract at the same rate in response to temperature changes and forces applied to the component (e.g., the first and second support legs have a substantially similar thermal conductivity). The size of the first support leg may be substantially the same as the size of the second support leg.

At block 422, the first support leg may be positioned at an angle relative to the second support leg. For example, the first support leg may be positioned at an angle of approximately 30 to approximately 60 degrees relative to a surface of the component onto which the first support leg is mounted (at block 410). The angle at which the first support leg is positioned may be approximately equal to the angle at which the second support leg is positioned.

At block 424, the second end of the first support leg may be spaced apart from the second end of the second support leg by less than a thickness of the strain sensor located between the second end of the first support leg and the second end of the second support leg. For example, the spacing may be between approximately 70% to 80% of the thickness of the strain sensor located between the second end of the first support leg and the second end of the second support leg (at block 430) or between 50% and 80% of the thickness of the strain sensor. This spacing may allow the strain sensor to be held securely by the first and second support legs and allow movement of the component to the translated to the strain sensor by the first and second support legs.

At block 430, a strain sensor (e.g., sensor 130 shown in FIG. 1) may be located between a second end of the first support leg (e.g., end 124a of support leg 120a shown in FIG. 1) and a second end of the second support leg (e.g., end 124b of support leg 120b shown in FIG. 1).

At block 440, a strain of the component may be measured using the strain sensor. For example, during operation, the component may experience stress and strain and may move based on those forces. The movement of the component may be translated to the strain sensor via the first and second support legs. The strain sensor may measure the strain based on the movement of the first and second support legs.

Although FIG. 4 discloses a particular number of operations related to method 400, method 400 may be executed with greater or fewer operations than those depicted in FIG. 4. In addition, although FIG. 4 discloses a certain order of operations to be taken with respect to method 400, the operations comprising method 400 may be completed in any suitable order.

Although examples have been described above, other variations and examples may be made from this disclosure without departing from the spirit and scope of these disclosed examples.

1. An apparatus, comprising:
a first support leg;
a second support leg opposite the first support leg, the second support leg symmetric to the first support leg and having a size substantially similar as the first support leg; and
a strain sensor between an end of the first support leg and an end of the second support leg.

2. The apparatus of claim 1, wherein:
the first support leg includes a first fin; and
the second support leg includes a second fin.

3. The apparatus of claim 1, wherein the first support leg is positioned at an angle relative to the second support leg.

4. The apparatus of claim 1, wherein a spacing between the first support leg and the second support leg is selected based on a thickness of the strain sensor.

5. The apparatus of claim 1, wherein a surface area of the first support leg is based on at least one of a thermal conductivity of a material from which the first support leg is manufactured, an air flow across the first support leg, or an ambient air temperature of an environment surrounding the first support leg.

6. The apparatus of claim 1, wherein a surface area of the first support leg is based on at least one of an operating temperature of the strain sensor, an air flow across the first support leg, or an ambient air temperature of an environment surrounding the first support leg.

7. The apparatus of claim 1, wherein a thermal conductivity of the first support leg and a thermal conductivity of the second support leg is substantially similar.

8. A method, comprising:
mounting a first end of a first support leg on a surface of a component;
mounting a first end of a second support leg on the surface of the component opposite the first support leg, the second support leg symmetric to the first support leg and having a size substantially similar as the first support leg; and
locating a strain sensor between a second end of the first support leg and a second end of the second support leg.

9. The method of claim 8, wherein:
the first support leg includes a first fin; and
the second support leg includes a second fin.

10. The method of claim 8, comprising positioning the first support leg at an angle relative to the second support leg.

11. The method of claim 8, comprising spacing the second end of the first support leg apart from the second end of the second support leg is selected based on a thickness of the strain sensor.

12. The method of claim 8, wherein a surface area of the first support leg is based on at least one of a thermal conductivity of a material from which the first support leg is manufactured, an air flow across the first support leg, or an ambient air temperature of an environment surrounding the first support leg.

13. The method of claim 8, wherein a surface area of the first support leg is based on at least one of an operating temperature of the strain sensor, an air flow across the first support leg, or an ambient air temperature of an environment surrounding the first support leg.

14. The method of claim 8, wherein a thermal conductivity of the first support leg and a thermal conductivity of the second support leg is substantially similar.

15. A system, comprising:
a mechanical component;
a strain gauge to measure a strain of the mechanical component, the strain gauge including:
a first end of a first support leg mounted on the mechanical component;
a first end of a second support leg mounted on the mechanical component opposite the first support leg, the second support leg symmetric to the first support leg and having a size substantially similar as the first support leg; and
a strain sensor between a second end of the first support leg and a second end of the second support leg.

16. The system of claim 15, wherein:
the first support leg includes a first fin; and
the second support leg includes a second fin.

17. The system of claim 15, wherein the first support leg is positioned at an angle relative to the second support leg.

18. The system of claim 15, wherein a surface area of the first support leg is based on at least one of a thermal conductivity of a material from which the first support leg is manufactured, an air flow across the first support leg, or an ambient air temperature of an environment surrounding the first support leg.

19. The system of claim 15, wherein a surface area of the first support leg is based on at least one of an operating temperature of the strain sensor, an air flow across the first support leg, or an ambient air temperature of an environment surrounding the first support leg.

20. The system of claim 15, wherein a thermal conductivity of the first support leg and a thermal conductivity of the second support leg is substantially similar.
